(19) United States
(12) Patent Application Publication
(10) Pub. No.: US 2020/0282754 A1
(43) Pub. Date: Sep. 10, 2020

(54) LASER PRINTED PHOTO ON GLASS ARTICLE METHOD THEREOF

(71) Applicant: ENG KAH ENTERPRISE SDN. BHD., Penang (MY)

(72) Inventor: Eng Kah EWE, Penang (MY)

(21) Appl. No.: 16/063,491

(22) PCT Filed: Aug. 15, 2016
(86) PCT No.: PCT/MY2016/000050

§ 371 Date: Jun. 18, 2018

(30) Foreign Application Priority Data
Dec. 16, 2015 (MY) 2015704589

(51) Int. Cl. B41M 1/34; B41M 5/26; G03G 13/10; G03G 15/22; G03G 7/00

(52) U.S. Cl. CPC B41M 1/34; B41M 5/262; G03G 7/0093; G03G 15/224; G03G 13/10

(57) ABSTRACT

The present invention generally relates to a method of glass article laser printing of photo images (with 3D or emboss effect) (1), comprising steps of: pre-treating said glass article with acid or alkali solution (12), coating a layer of composition on said article (14), ageing said article surface under room or ambient temperature, laser-printing on said glass article surface (16) with at least a laser printing means, and surface finishing said glass article surface by heating process (18). Alternatively, said surface finishing can be achieved by ultra-violet light irradiation, washing with fluid, lamination, or a combination thereof.

### 1. TECHNICAL FIELD OF THE INVENTION

The present invention generally relates to a method of glass article laser printing of photo images (with 3-dimension (3D) or emboss effect), comprising steps of: pre-treating said glass article with acid or alkali solution, coating a layer of composition on said article, ageing said article surface under room or ambient temperature, laser-printing on said glass article surface with at least a laser printing means, and surface finishing said glass article surface by heating process. Alternatively, said surface finishing can be achieved by ultra-violet light irradiation, washing with fluid, lamination, or a combination thereof.

### 2. BACKGROUND OF THE INVENTION

Laser printing is widely known technique to transfer CMYK (cyan, magenta, yellow, and key/black) color toners to a charged article surface; the charged article surface is achieved by streams of laser irradiation. Such technique is only limited to fibrous substrate such as paper, plastic, or metal. Direct color printing on glass can only be achieved through silk screen printing. The color printing is limited to few types of colour output, and unable to portray image sharpness of photo image.

Other known method such as hydro transfer or hydro-printing as disclosed in JP2009083281 (A) and CN 103042875 A by means of water transfer printing paper. However, such printing requires numerous of process steps and not able to produce color and image sharpness of a photo image. Besides, the printed surface using the said technique will be smooth and glossy, unlike the present invention which is able to produce 3D or emboss printed image.

Therefore, the present invention can offer a solution to alleviate aforesaid shortcomings in the conventional glass article printing by direct laser irradiation and color printing on the glass article surface.

### 3. SUMMARY OF THE INVENTION

Accordingly, it is the primary aim of the present invention to provide a method to laser print photo images and inscriptions directly on a glass article surface.

It is yet an object of the present invention to provide a method print monochrome or colored images, or inscriptions on glass articles.

It is yet an object of the present invention to replace indirect and conventional glass article printing such as hydro-printing or silk screen printing.

It is yet an object of the present invention to apply laser printing onto glass article surface.

It is yet an object of the present invention to enable a laser printing imagery resolution of at least 3,000 pixels per inch (118 pixels per mm) on the glass article.

It is yet an object of the present invention to provide said glass article surface with laser printing resistance to artificial light, sunlight, hydrocarbons such as alcohol, aromatic hydrocarbons such as perfume, and water.

According to the preferred aspect of the present invention there is provided,

A method of glass article laser printing of photo images (1), comprising steps of:

i. coating a layer of composition on a treated glass article surface (14);

ii. ageing said glass article surface from step (14) at room or ambient temperature;

iii. laser-printing said glass article surface (16) with at least a laser printing means; and

iv. surface finishing said glass article surface in step (18) by a heating process;

characterized in that

said composition comprising ink/color pigment, thinner, catalyst, wetting agent, solvent, binder, flow agent, defoamer, resin, or a combination thereof; and

said glass article surface finishing further comprising ultra-violet light irradiation, washing with fluid, lamination, or a combination thereof in step (18).

According to the preferred embodiment of the present invention the following is provided,

A glass article laser printing of photo image (2), comprising:

a glass article (20);

a layer of composition (24) is applied on said surface (20) thereon;

characterized in that

said layer of composition (24) is applied by a laser printing means (26) capable of receiving imagery data files or formats from a computing means (28); and

said laser printing means (26) is capable to print photo imagery.

### 4. BRIEF DESCRIPTION OF THE DRAWINGS

Other aspect of the present invention and their advantages will be discerned after studying the Detailed Description in conjunction with the accompanying drawings in which:

FIG. 1 shows an exemplary method to produce a laser printing glass article for photo image.

FIG. 2 shows a side view of the present invention.

### 5. DETAILED DESCRIPTION OF THE DRAWINGS

In the following detailed description, numerous specific details are set forth in order to provide a thorough understanding of the invention. However, it will be understood by the person having ordinary skill in the art that the invention may be practised without these specific details. In other instances, well known methods, procedures and/or components have not been described in detail so as not to obscure the invention.

The invention will be more clearly understood from the following description of the embodiments thereof, given by way of example only with reference to the accompanying drawings, which are not drawn to scale.

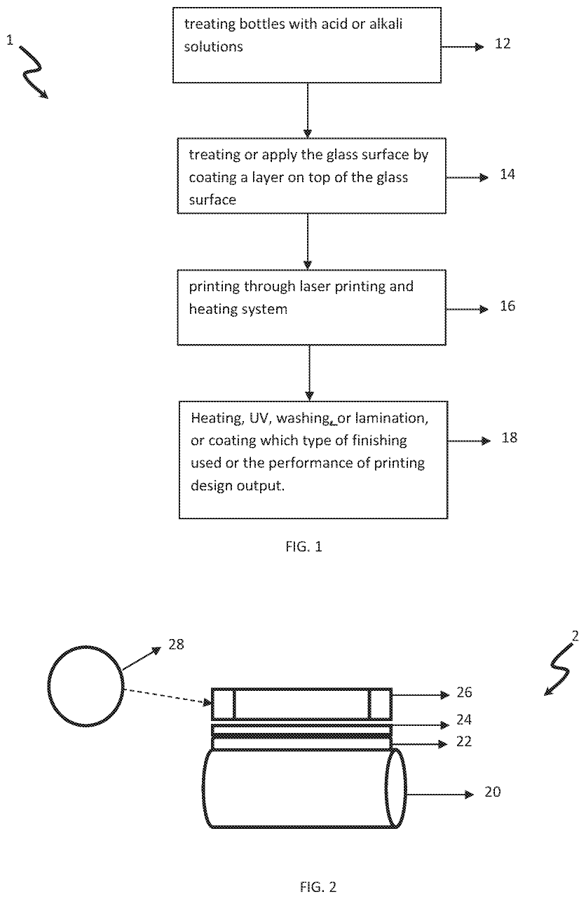

Referring now to FIG. 1, there is shown an exemplary method of glass article laser printing of photo image (1), comprising steps of: coating a layer of composition on a treated glass article surface (14); ageing said glass article surface from step (14) at room or ambient temperature; laser-printing said glass article surface with at least a laser printing means; and surface finishing said glass article surface in step (18) by a heating process.

Said composition comprising ink/color pigment, thinner, catalyst, wetting agent, solvent, binder, flow agent, defoamer, resin, or a combination thereof; and said glass article surface finishing further comprising ultra-violet light irradiation, washing with fluid, lamination, or a combination thereof.

Alternatively, said glass article surface is pre-treated with acid or alkali solution (12). The surface is allowed to dry before proceed to step (14).

Referring to FIG. 2, there is shown a side view of the present invention. A glass article laser printing of photo image (2) comprising; a glass article (20), a layer of composition (24) is applied said article (20) thereon, at least a laser printing means (26) abuts said layer (24) to enable color toners transfer thereon. Said laser printing means (26) receives photo imagery data files or formats:—for example, raster and/or vector formats such as JPG, GIF, PNG, BITMAP(BMP), TIFF, SVG, or the like, from a computing means (28) demarcated by a dotted arrow, abuts said layer of composition (24) to enable color toners transfer thereon. Alternatively, a layer of acid or alkali solution (22) is disposed said glass article (20) surface and the layer of composition therebetween (24).

Said laser printing is preferably color toner type comprising CYMK (cyan, yellow, magenta, and key/black) color toners; however, it can produce a monochrome or color printing, or a combination thereof, on said glass article surface. Preferably, glass article is a bottle, jar, container, or the like with flat, curve, or uneven surface. The laser printing means is capable to print imagery resolution of preferably more than 3,000 pixels per inch (118 pixels per mm). However, other imagery resolution is still applicable as long as portrays a clear image.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative only and other embodiments may be selected without departing from the scope of the present invention, as set forth in the claims appended hereto.

1. A method of glass article laser printing of photo image, comprising steps of:
i. coating a layer of composition on a treated glass article surface;
ii. ageing said glass article surface from step at room or ambient temperature;
iii. laser-printing said glass article surface with at least a laser printing means; and
iv. surface finishing said glass article surface in step by a heating process;
characterized in that
said composition comprising ink/color pigment, thinner, catalyst, wetting agent, solvent, binder, flow agent, defoamer, resin, or a combination thereof; and
said glass article surface finishing further comprising ultra-violet light irradiation, washing with fluid, lamination, or a combination thereof in step.

2. The method of glass article laser printing of photo image as claimed in claim 1 wherein said glass article surface is pre-treated by acid or alkali solution.

3. The method of glass article laser printing of photo image as claimed in claim 1 wherein said laser-printing means is toner type comprising CYMK (cyan, yellow, magenta, and key/black) color toners.

4. The method of glass article laser printing of photo image as claimed in claim 1 wherein said laser-printing means receives photo imagery data files or formats from a computing means.

5. The method of glass article laser printing of photo image as claimed in claim 1 wherein said laser-printing means is capable to print photo imagery resolution of more than 3,000 pixels per inch (118 pixels per mm).

6. The method of glass article laser printing of photo image as claimed in claim 1 wherein said laser-printing means produces monochrome or color printing, or a combination thereof, on said glass article surface with 3D (dimensional or emboss effect).

7. The method of glass article laser printing of photo image as claimed in claim 1 wherein said glass article is a bottle, jar, or container with flat, curve, or uneven surface.

8. A glass article laser printing of photo image, comprising:
a glass article;
a layer of composition is applied on said surface thereon;
characterized in that
said layer of composition is applied by a laser printing means capable of receiving imagery data files or formats from a computing means (28); and
said laser printing means is capable to print photo imagery.

9. A glass article laser printing of photo image as claimed in claim 8, wherein said photo imagery is with resolution of more than 3,000 pixels per inch (118 pixels per mm).

10. A glass article laser printing of photo image as claimed in claim 8, wherein said photo imagery is with 3-dimensional (3D) or emboss color image.
